(19) United States
(12) Patent Application Publication
(10) Pub. No.: US 2007/0165131 A1
(43) Pub. Date: Jul. 19, 2007

(54) System and method for measuring tilt of a sensor die with respect to the optical axis of a lens in a camera module

(75) Inventors: Carmel Ish-Shalom, Alameda, CA (US); Pimai Seelao, Fremont, CA (US)

Correspondence Address: STEVENS LAW GROUP, P.O. BOX 1667, SAN JOSE, CA, 95109, US

(73) Assignee: ESS Technology, Inc., Fremont, CA (US)

(21) Appl. No.: 11/479,406

(22) Filed: Jun. 30, 2006

Related U.S. Application Data
(60) Provisional application No. 60/749,867, filed on Dec. 12, 2005.

(51) Int. Cl. G03B 13/00

(52) U.S. Cl. 348/345

(57) ABSTRACT

A system and method are provided for measuring tilt of a sensor die with respect to the optical axis of the lens assembly in a camera module by providing a camera module having a sensor die with a plurality of focal indicial located on a surface, and a lens or lens assembly adjustably held about the sensor die and having an optical axis; exposing the lens to light; measuring the focus of each focal indicia with respect to the position of the lens; and calculating the tilt of the sensor die with respect to the optical axis of the lens.

### RELATED APPLICATION

The application claims the benefit of the filing date for U.S. Application No. 60/749,867 filed on Dec. 12, 2005.

### BACKGROUND

The manufacture and testing of miniature camera assemblies are well known in the art, and many methods exist to build and test such assemblies for quality assurance. However, now that camera components are becoming smaller, and as demand for higher quality continues to increase, conventional testing techniques are becoming obsolete. In particular, the manner in which to measure accurately the sensor die tilt relative to the optical axis of a lens or lens assembly in a camera module in development and manufacturing is very difficult, and cannot be done well given conventional techniques. Typically, a measurement may be made after the die is attached to the lens holder or related assembly, and possibly a measurement may be made when a die is connected, whether by adhesive or solder connection. These are never accurate, particularly because many factors affect the tilt measurement after the camera assembly is completed. Also, as devices get smaller, the sensor die get thinner, and lenses are also getting reduced in size. With better quality cameras coming in demand, the manufacturing environment requires more accurate testing and measuring

Typically, manufactures make mechanical measurement of die to substrate tilt and holder to substrate tilt. The combination does not take into account other possible sources of tilt, and the cumulative accuracy of the addition of tilts when the entire assembly is completed is very limited. This is because, once the assembly is complete, there is no method that exists to measure the tilt of the internal components.

Therefore, there exists a need in the art to measure the tilt of a sensor die with respect to the optical axis of the lens assembly, whether it consist of single or multiple elements, and also a need for focusing a lens assembly with respect to the sensor die chip for consistent quality and accuracy.

### THE FIGURES

FIG. 1 is an expanded view of a camera assembly according to the invention;

FIG. 2 is an assembled view of the camera assembly according to FIG. 1;

FIG. 3 is another view of the camera assembly of FIG. 1 in relation to a substrate;

FIG. 4a is cut-away illustration of a camera assembly of FIG. 1;

FIG. 4b is a simplified version of a die and substrate in relation to a lens assembly;

FIG. 5 is a diagrammatic view of an expanded view of the camera assembly with respect to a motor assembly and controller;

FIG. 6 is a simplified illustration of a camera assembly showing the relation of the component orientations to the optical axis;

FIG. 7 is an illustration of a sensor surface with indicia locations identified;

FIG. 8 is an illustration of the sensor surface of FIG. 7 in relation to the lenses of a camera assembly;

FIG. 9a is a plot of Mm values measured on a sensor surface;

FIG. 9b is a plot of MTF values measured at different indicia locations on a sensor surface;

FIG. 9c is a plot of actual MTF values measured from a sensor surface;

FIG. 10 is a system configured for measuring tilt according to the invention;

FIG. 11 is a flow diagram of a method of measuring tilt according to the invention; and

FIGS. 12a-c illustrate different types of tilt measurement devices according to the invention.

### DETAILED DESCRIPTION

In this method the completed module or cube is tested for precise tilt measurement of the optical axis relative to the sensor surface using multiple positions on the sensor die. The method provides precise positioning of the lens and precise movement of the lens while measuring the position and the focus quality at different measurement locations on the die, optimally in five locations. Focus quality is measured by means of MTF. Once the data is collected, optimal focus is extracted for each measurement position and the tilt can be easily calculated by knowing the location of the measurement points on the imager die to a substantial certainty. These measurements can be compared to a predetermined threshold, or pass values, to determine whether the tilt of the die with respect to the optical axis is acceptable for a given application.

Prior measurement methods have inherent difficulties in precision of each component of the mechanical measurement and the combination of the measurements. Also, prior solutions do not take into account the optical component of the tilt in the system. With this method, tilt can be added to the production test very easily and improve the quality of the end product, such as a mobile phone camera.

As cameras progress, the trend is to go to thinner substrates thus possibly to more variability in the tilt due to the lower rigidity of the substrate. With this novel system and method of measurement in the production test, the quality of the camera can be improved by screening out cameras with excessive tilt. Another advantage is the usefulness of this method in the development of new processes for die attachments in camera modules.

The Modulation Transfer Function (MTF) is a fundamental imaging system design specification and system quality metric often used in remote sensing. Many methods are well known by those skilled in the art. MTF may be defined as the normalized magnitude of the Fourier Transform of the imaging system's point spread function. Alternatively, the MTF describes the attenuation of sinusoidal waveforms as a function of spatial frequency. Practically, MTF is a metric quantifying the sharpness of the reconstructed image based on light rays captured by a light sensor over an area range. MTF measurement techniques are well known for quantifying the along scan and cross scan MTF profiles. Many measurement techniques exist that are designed to provide accurate measurements for high resolution imaging systems. Additionally, a confidence interval is assigned to the measurement as a statement of the quality of the measured value. The classical slant-edge measurement technique for discrete sampled systems may be employed. Fixed high-contrast targets are used to obtain MTF measurements in the center of the array. As access to such targets is limited, suitable edges for analysis are identified in nominal operational imagery. The measurement results from the specialized targets are used to confirm the large number of measurements from the operational imagery.

Multiple methods have been proposed for determining the MTF of remote sensing systems. These include imaging lines or points and potentially using imagery from a system with known MTF. In general, these measurement techniques require a particular size and orientation of targets based on the GSD and scan direction of the sensor to achieve good performance. Another approach is to use edges to determine MTF. The edge spread function (ESF) is the system response to a high contrast edge. The derivative of the ESF produces the line spread function (LSF), which is the system response to a high contrast line. The normalized magnitude of the Fourier Transform of the LSF produces a one-dimensional slice through the two-dimensional MTF surface. Other methods exist for computing the system MTF directly from the ESF that remove the-need for differentiation. A requirement for determining MTF from edges is to have a high fidelity representation of the ESF. The slanted edge algorithm uses the change in phase of the edge across the sampling grid to create a “super-resolved” ESF.

According to the invention, the MTF values measured from the die serve as measuring points for determining relative distances among the different die positions and ultimately measuring the tilt of the die with respect to the optical axis.

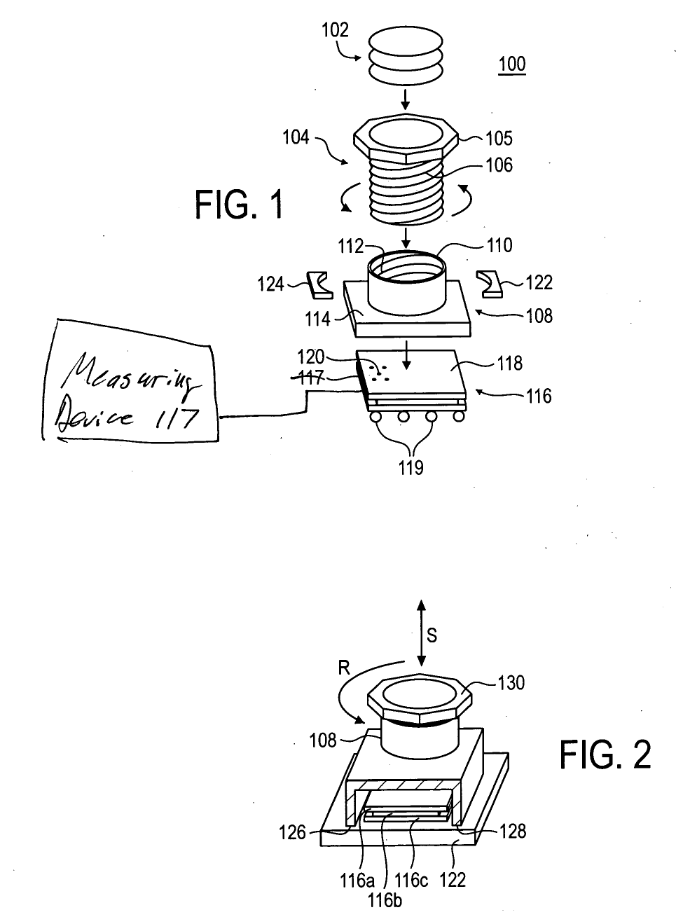

Referring to FIG. 1, an expanded view of a camera module, according to the invention is illustrated. Several of the components of the camera assembly are well known to those in the art, however, their use and interconnection and improvements made, according to the invention, are novel and useful. One component of the camera module is the sensor die 116, which has site points 120. According to the invention, the distance between these points are measured in order to determine the tilt of the die with respect to the optical axis of the lenses.

Still referring to FIG. 1, the camera assembly 100 may include one or a plurality of lenses 102 that are held within the lens assembly 104. The lens assembly may include an octagonal rim 105 and threads 106. In operation, the octagonal rim can be used to engage with a complementary attachment for turning the lens assembly within the lens assembly holder 108, in order to adjust the focal position of the lenses. One means of making such adjustments is described below. The threads 112 within the lens assembly holder are complimentary to the threads 106 of the lens assembly, thus, the lens assembly can be rotated within the inner threads 112 of the lens assembly holder to adjust the focal position of the lens or lenses within the lens assembly. The significance of this function will be discussed below.

Still referring to FIG. 1, the lens assembly holder 108 includes inner threads 112 that are located within the lens assembly cavity 110. The lens assembly cavity 110 is part of the lens assembly holder base 114. In the final assembly, this base is mounted over and around the sensor chip 116, sealing the sensor chip between the cup-like cavity of the lens assembly holder and the surface of the substrate on which the die is mounted. Thus, the lens assembly is cupped over the die to cover the die and to seal off the die. A measuring device 117 is configured to communicate with the sensor chip in order to measure different aspects of light rays that travel through the lenses within the lens assembly, through the lens assembly holder and onto the surface 118 of the chip that includes optical adjustment sight points 120.

The optical adjustment sight points may be predetermined areas of the sensor chip, an area of 40 by 40 pixels for example, that are generally or specifically located in a predetermined location. These points are focused on and used for determining and measuring the amount of tilt of the die chip with respect to the optical axis. These areas may not be separate entities of their own, and are preferably certain areas of pixels that occur on all of the chips produced in a production system. These are located at predetermined and consistent locations, where their dimensions, the distances between points, are known. The points are specifically chosen according to the particular application. Once the assembly is complete, the points can be measured to determine if and to what extent the die is tilted with respect to the optical axis of the lens holder assembly. Those skilled in the art will understand that there are many configurations and options in choosing areas on which to focus, including whether to focus on horizontal or vertical lines or other aspects of the focal area. Thus, the invention is not limited to any particular type or size of area on which to focus to measure the tilt of the die with respect to the optical axis of the lens holder assembly.

According to the invention, in a testing phase, light travels through the lenses 102 and on through the lens assembly and lens assembly holder and onto the sensor chip surface, where the light rays are measured by the sensors pixels located on the sensor chip. The measurement points 120, which are predetermine groups of pixels located on the surface of the sensor chip for measurement purposes, allow a testing device to determine the quality of the correspondence between the optical axis of the lenses and the focus quality at these points. Since this is a camera assembly, it is imperative that the light that travels through the lenses and on to the sensor chip, then accurately captured and recorded for quality camera operations, resulting in quality photos. If the chip is tilted too far from an optimal angle with respect to the optical axis of the lens or lens assembly, then the images may not be focused across the entire picture frame.

Referring to FIG. 2, an assembled version of the camera assembly of FIG. 1 is illustrated. The holder covers and seals the die and is mounted around the die on the substrate. The die is simply illustrated as a single entity. However, die mounting designs vary widely, and may be one of among many variations. Regardless, in any type of mounting configuration, the invention is still able to measure the tilt of the sensor surface with respect to the optical axis, and independently from the manner in which the sensor die is mounted. The invention is able to measure and calculate the tilt of the sensor surface with respect to the optical axis by measuring the MTF values on predetermined locations on the sensor surface. The tilt can then be measured by measuring the distance between maxima MTF points at the sensor locations. In one embodiment, the measurements are taken at five locations on the sensor surface, where the tilt is then determined relative to each of the five locations. Using these measurements, the tilt can be calculated by measuring the distance between the maxima MTF points, and determining the tilt in several directions.

Referring to the break-out portion of FIG. 2, a practical structure may include a sensor die 116a that has a sensor surface 118 (FIG. 1). The sensor may be mounted on a spacer 116b that is located between the sensor and another die 116c. The die 116c may be directly mounted on a substrate 122 as illustrated. Again, mounting designs for dice and sensors vary a great deal, and different configurations may be possible, but the invention is directed to measuring the tilt of the sensor surface with respect to the optical axis independently of the type of mounting configuration. The configuration shown is but one example, and other variations are possible without departing from the spirit and scope of the invention, which is defined by the appended claims. The terms “die” or “die surface” as used herein are intended in the generic sense, and references to the die is intended to transcend particular configurations or embodiments.

Still referring to FIG. 2, in operation, the octagonal rim 130 may be caused to be rotated, thus rotating the lens assembly and the associated lenses, varying the distance of the lenses from the surface of the sensor chip. The braces 122 and 124 can be configured to hold the camera assembly in place for this process. These braces may be mounted on mounts 126, 128, in order to keep the camera assembly stable, thus keeping the light readings consistent. Thus, in operation, the “R” rotating motion causes the lens assembly to move in the perpendicular direction “S” and varies the distance of the lenses with respect to the sensor chip. Such an assembly is common for use in camera phones and other applications. The invention is directed to a system and method of measuring the tilt angle of such an assembly.

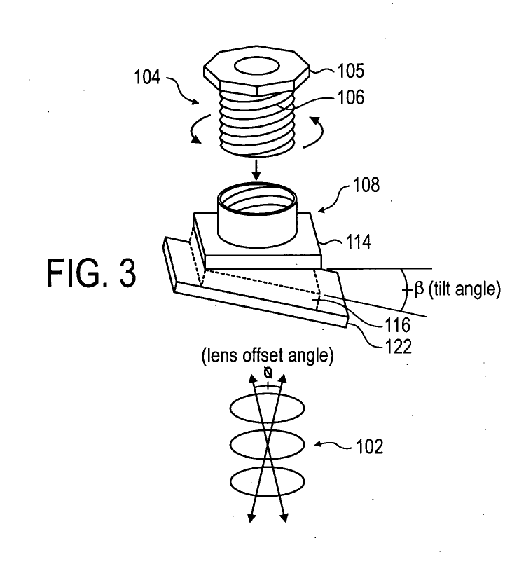

As discussed in the background, one of the problems related with such camera assemblies is the amount of tilt of the sensor chip with respect to the optical axis of the lens or lens assembly. Referring to FIG. 3, there are many factors illustrated that cause the sensor chip to be tilted with respect to the optical axis of the lenses when the final assembly is complete. In the production process, if it is discovered that this tilt angle is too far out of specification, the result is a poor quality picture. One of the variances is a tilt angle, beta, between the lens assembly holder 108 and the sensor chip 116, shown in an exaggerated manner in FIG. 3.

Tilt can be caused by several manufacturing variables. In stacked die applications, there may be as many as 3 dice stacked where each one of them has some tilt contribution. This would contribute to tilt of the stacked die with respect to the optical axis. Also, the lens holder, which is mounted on the substrate about the die, can contribute to tilt of the lens assembly. The lenses within the lens holder can also contribute to the tilt, where each element of the lens assembly may have individual contribution to the overall tilt. The lens assembly is not always built in the same cavity or in reference to the same cavity, so further error variables can occur with respect to the thread alignment and overall orientation of the lens assembly after it is installed in the lens holder. Also, distortion in any one lens can also contribute to tilt, as imperfections of any lens affects the optical axis of the lenses assembled within the lens holder.

The holder is mounted over and around the sensor chip. The sensor chip is also mounted on a substrate either via glue or via solder connections, which can also cause a tilt of the sensor chip with respect to the lens assembly. One other factor, still referring to FIG. 3, is the lens offset angle theta caused by the offset of the lenses themselves 102. Thus, many factors can affect the quality of a camera assembly. In production, however, once the assembly is completely assembled, is difficult if not impossible to measure the tilt angle of the sensor ship with respect to the optical axis of the lenses-using conventional methods. According to the invention, such measurement can be made in an elegant manner without the need to manually measure the actual assembled components.

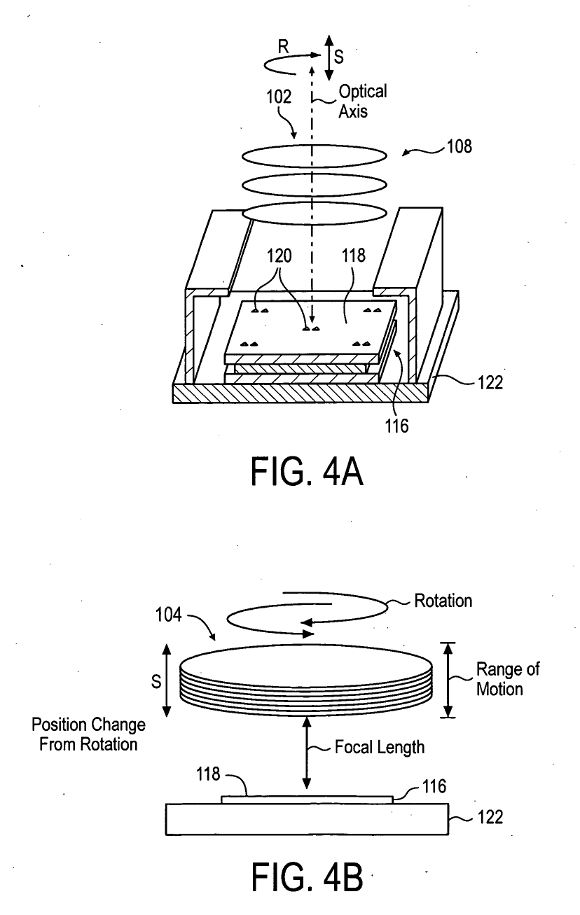

Referring to FIG. 4a, a partially assembled camera assembly is shown in relation to the sensor chip 116. The lens assembly 104 can be rotated in directions “R” in order to move the lenses themselves in a vertical manner “S” with respect to the lens assembly holder 108 in order to vary the focal position. Referring to FIG. 4b, a more simplified view of the lens assembly 104 is illustrated, where rotation R corresponds to a change in position S of the lens assembly. Given a particular camera module, a limited range of motion exists in varying the focal position between the lens assembly 104 and die 116. A holder can be configured to hold the camera assembly in place in order for the lens assembly 104 to move and change the focal position with respect to the sensor chip 116. The sensor ship 116 is shown separated from the camera assembly in order to show the optical focus points 120 that are located in predetermined locations on the surface 118 of the optical sensor chip. According to the invention, the optical lens assembly 104 can change the focal position, and can be used to focus in and measure a focus value on the focus points 120 in order to determine the amount of tilt of the sensor chip 116 with respect to the optical axis of the lens or lenses held by the rest of the assembly 107. Referring again to FIG. 4a, a more simple view of the camera assembly is illustrated, where the die 116 is mounted on substrate 122, and the lens assembly 108 is mounted over and about the sensor die and on the substrate to seal in the die. In operation, the measurements are taken of the focal points on the die to determine the tilt of the die with respect to the optical axis. Variances in the mounting of each component on the substrate can affect the tilt of the die with respect to the optical axis.

Once this measurement is determined, the quality of the camera assembly in general can be determined with respect to the amount of tilt. For example, in practice, the tilt may be measured in microns, and 20 microns of tilt may be a threshold, where cameras that have more than 20 microns of tilt with respect to the optical axis would be outside the threshold, and would be considered bad quality. Once the quality of the camera assembly is determined, quality control can then use the results in making production and design recommendations. Using systems and methods configured according to the invention, the quality of the entire design and production process can be improved.

In operation, depending on the quality of the picture or photograph desired by a given camera assembly, a tolerance of tilt measurements can be predetermined. If the sensor chip 116 is too far tilted with respect to the optical axis of the lens assembly 104, then the camera assembly can be discarded and not moved forward in assembly for the final product. Also, the camera assembly may be used as a statistical sample of a number of camera assemblies for testing quality in a system that produces volumes of camera assemblies. The final products may be a hidden camera spy assembly, a camera used on a cellular phone, still fixed focus camera or any other type of miniature camera assembly where a certain level of quality is desired. Prior to discovery of this invention, conventional methods included very crude manual measurements of the substrate with respect to the lens assembly or holder. However, once the camera assembly is completely assembled, it is difficult if not impossible to measure tilt of the sensor die with respect to the optical axis.

The conventional tolerance of tilt angle measurement was acceptable in older conventional systems when cameras were first introduced into cellular telephones. In such applications, the quality of the photograph was not as important to the consumer. And, the measurement of the tilt angle was not done, because it could not be done accurately. The overall assembly was optimized, but measurement of the final assembly could not be measured. However, consumers are now requiring and manufacturers are now striving to provide higher quality cameras on cellular phones, two Mega-pixel resolution and above are getting to be popular, thus requiring more accurate camera assemblies as those illustrated herein. According to the invention, a testing and measuring method and system are provided for determining the quality of the camera assemblies after they are assembled by measuring the tilt of the sensor chip with respect to the optical axis of the lens holder 104. Another advantage for this invention is that the tilt measurement can be easily integrated into the automatic focusing of the camera during production with no additional hardware needed.

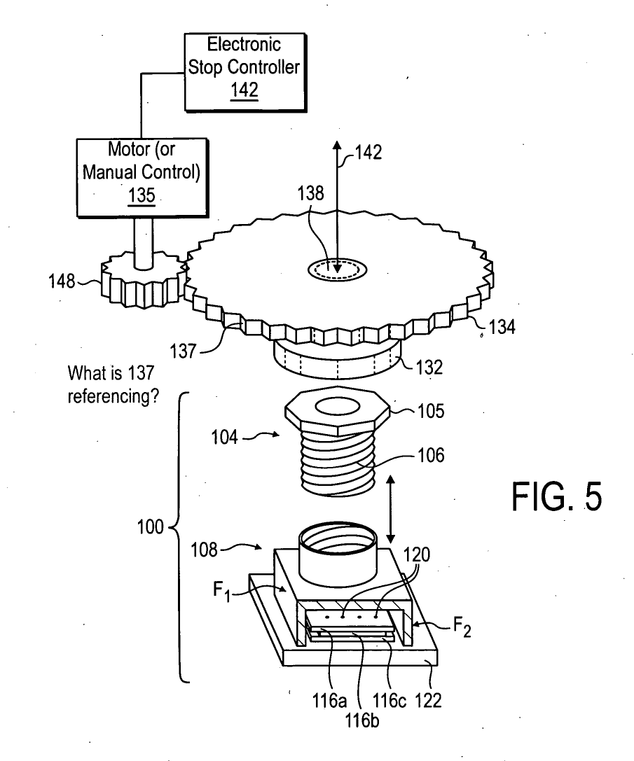

Referring to FIG. 5, a more detailed assembly, a diagrammatic view of a system for testing the tilt of a sensor chip to a lens assembly is illustrated. The methods of measuring tilt discussed above must be mechanized due to the needed precision in the lens movement, or by using an assembly such as that shown in FIG. 5. FIG. 5 is presented as one embodiment of a system and method of performing such measurements. In one embodiment, the sensor chip 116 is connected to the lens assembly holder 108, which is configured to receive the lens assembly 104 via the threads 106. The octagonal rim 105 is configured to be received in the lens assembly lock 132, which has a corresponding octagonal shaped aperture that is configured to fit the octagonal rim 105 within a certain tolerance. In operation, when the assembly turns, the lens assembly lock connected to the lens assembly 104 can rotate the lens assembly with respect to the lens assembly holder that is held in place, by holders 122, 124 of FIG. 1 for example. As the lens assembly 104 rotates, the lenses within (not shown) are moved in relation to the surface of the sensor chip having sensor points 120.

Still referring to FIG. 5, a focal adjustment gear 134 is connected with a common central axis of the lens assembly lock 132. This focal adjustment gear may be connected to a motor control 135 in order to adjust the lens assembly 104. The focal adjustment gear 134 may be operated by an electronic motor 135 and is controlled by electronic step controller 142.

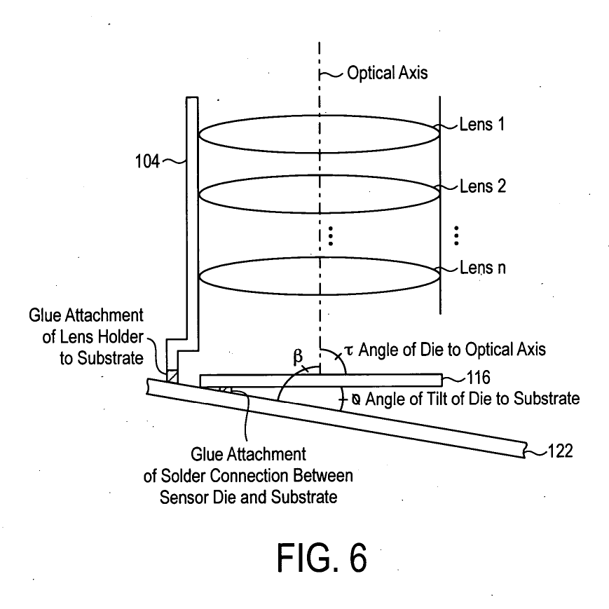

Referring to FIG. 6, a diagrammatic view of the lenses with respect to the sensor die is illustrated. The lens holder 104 holds a plurality of lenses lens 1, lens 2, . . . lens N. These lenses define an optical axis which is projected onto the surface of the sensor die chip 116 at an angle τ, (tao), which is an angle of a die with respect to the optical axis. This angle, optimally, should be 90 degrees. However, in production, this angle is not always ideal. This is a result of the imperfections in the lenses, imperfection in the lens holder holding the lenses, and other manufacturing factors. This angle can also be affected by assembly factors such as the glue attachment of the lens holder to the substrate, which can vary the manner in which the lens holder is connected to the substrate, causing a change in the angle of the die of the optical axis. Similarly, the sensor die chip 116 is glued or attached with a solder connection between the sensor die and the substrate causing an angle of tilt θ of the die with respect to the substrate. This tilt of the die, however it is caused, with respect to the optical axis, is that which the invention is directed to. When the assembly is complete, it is difficult or not possible to manually measure the angle of tilt of the sensor die with respect to the optical axis mechanically. Once the assembly is complete, this measurement cannot be done using conventional methods.

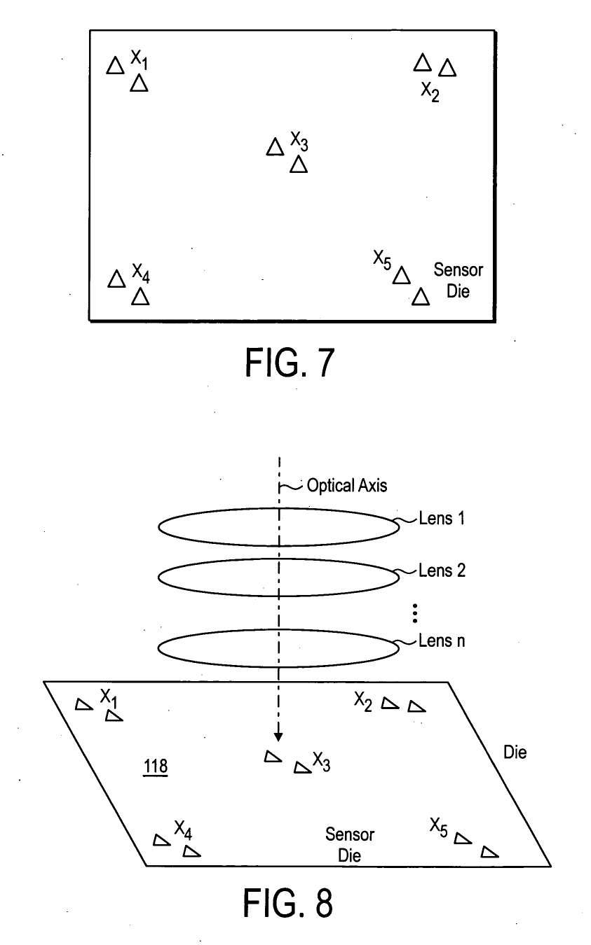

Again, the invention is directed to measurements of the tilt of the senor die with respect to the optical axis. Referring to FIG. 7, the surface of the die 118 is illustrated having optical indicia X1, X2, X3, X4, and X5. In a preferred embodiment, these indicia are predetermined areas on the sensor die. These indicia may vary in shape, form or size, and are used to determine the tilt of the sensor chip with respect to the optical axis of the lenses. Referring to FIG. 8, the same surface of FIG. 7 is illustrated with respect to the optical axis that is the subject of the lenses lens 1, lens 2, . . . lens N. In operation, the lens positioning is varied up and down with respect to the surface of the sensor die in a manner to determine the tilt of the optical axis with respect to the surface over the sensor die 118. Generally, this is done by focusing on each of the different optical indicia, recording the locations of the lens location where the MTF value is maximized, and recording the position of the lens with respect to the optical indicia in a linear manner. The lens position is recorded with respect to each indicia's maximized MTF value. A focus value is given for each applicable indicia and is recorded with respect to the location of the lens assembly. Thus, the lens location with respect to each indicia is known. Those skilled in the art will understand that the invention is not limited to any particular shape, location or number of indicia in any particular application, but that there are many variations of indicia that may be used, and the invention is not limited to any particular such application or variation.

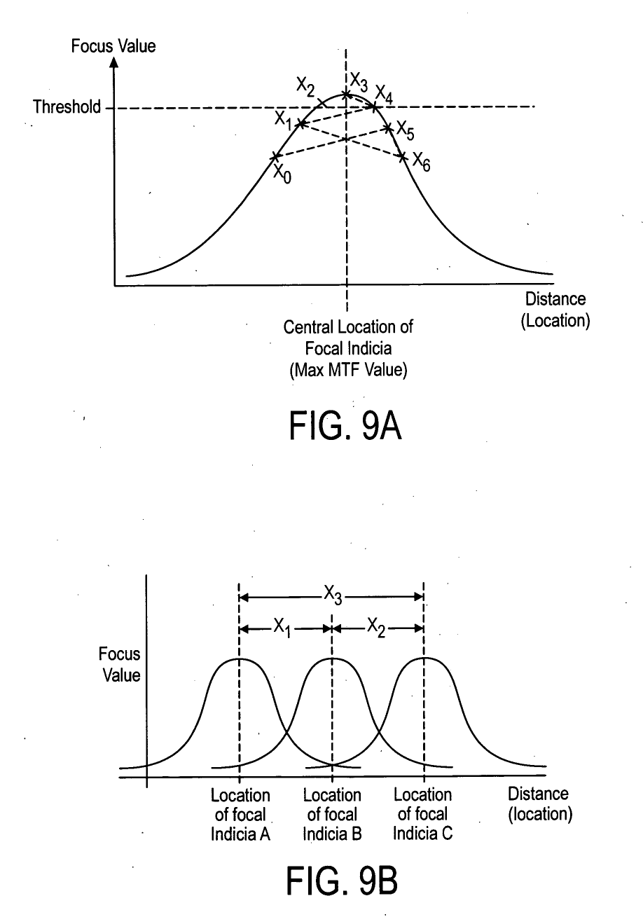

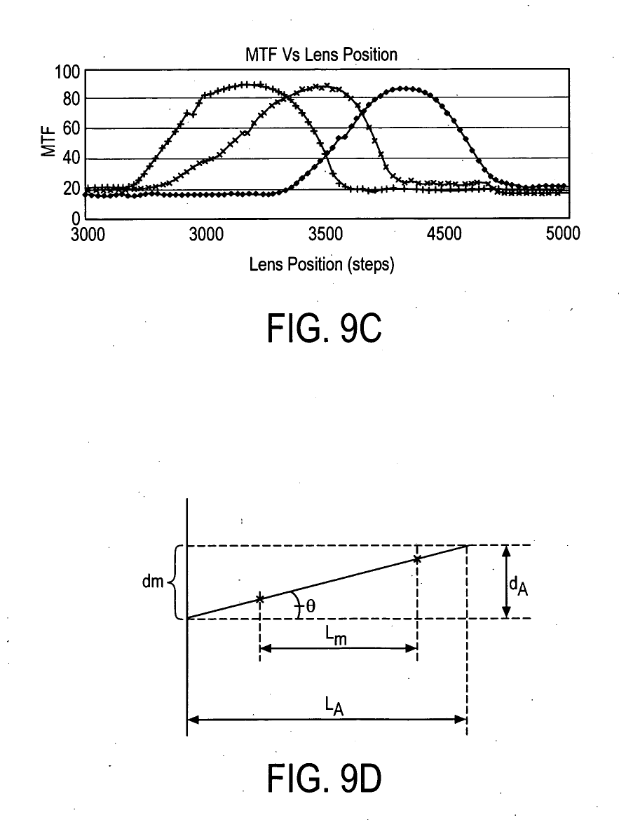

Referring to FIG. 9a, a graphical illustration of the recordation of the focus value with respect to the distance, that which is the position of the lens relative to the MTF value at each one of the indicia, is illustrated. The measurements are taken in a linear manner, beginning with X₀, then X₁, X₂, X₃, X₄, X₅, . . . , Xₙ. The maximum value of MTF is found for each measured location, each indicia, and the relative maximum value from each location is used for the calculation of distance between one point and another point. The absolute value of MTF is not necessary for the calculation, only the position of the maximum value relative to the lens position is required for the calculation of tilt. Referring to FIG. 9b, plot graphs of measurements taken from three different locations are illustrated. The distances, X₁, X₂, X₃, are measurements of the distances between relative maxima at each focal indicia. For example, the location of focal indicia A maxes out at one point, and a location of focal indicia B maxes out at another point, and also the location of focal indicia C maxes out at yet another point. At these focus value points, the distance between the different focal indicia can be determined (X1, X2, X3). Referring to FIG. 9c, an example of plots from an actual sensor surface is illustrated. Three indicia locations were measured in a linear manner, and their relative plots are shown superimposed in the graph. The lens position is on the horizontal axis, and is shown in terms of steps, where the steps are increments of change in position of the lens assembly. The MTF is plotted on the vertical axis, and MTF is in standard MTF terms, from 0 to 100. Since these focal indicia are pre-determined locations on the die, they can be used to determine the angle of tilt of the sensor die with respect to the optical axis. This is how it is determined whether or not the camera assembly is of an adequate quality such that the optical axis is at an adequate angle with respect to the die surface. In one embodiment of operation, the method of the invention is configured to measure the distance between the points. Then, the two most extreme distances are calculated. This allows for the calculation of the tilt in the most extreme case. Using these measurements, tilt can be measured in any direction on the chip. In this example, three points are shown with measurements. However, in practice, the tilt of the two dimensional surface of the sensor chip with respect to the one dimensional optical axis can occur in multiple directions. Therefore, a better method would include measurements of at least 5 points to determine the tilt in all relevant directions.

In practice, the lower the tolerance-of the tilt, the better the picture quality will be. This method allows for improvement in the quality of the camera modules manufactured. It also reduces the cost of manufacturing by increasing the throughput of the factory because the tilt measurement is a by product of the focusing process without adding test time, and reducing rework of poorly assembled modules.

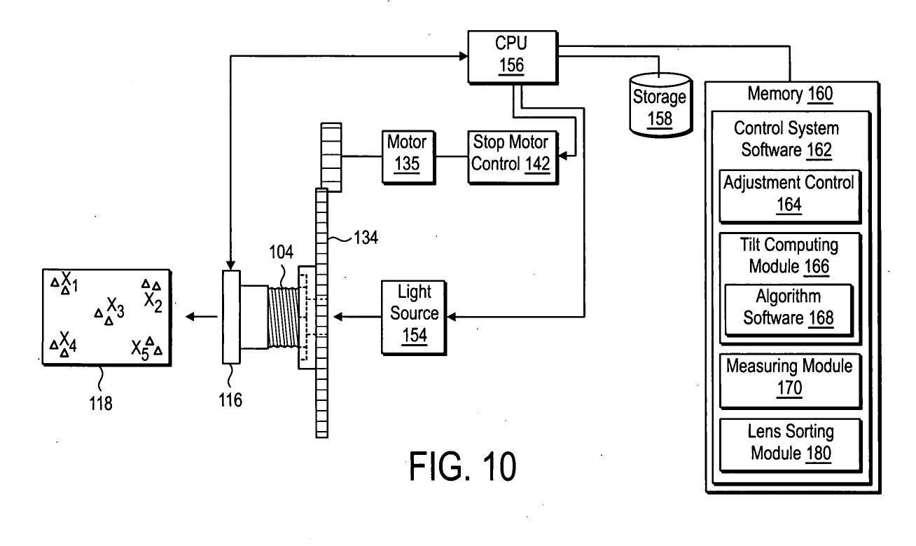

Referring to FIG. 10, an automated system configured according to the invention is illustrated. The system is similar to that shown in FIG. 5, but now includes a CPU 156 configured to automatically measure and calculate the tilt of the sensor die 116 by measuring focus of the focal indicia X1, X2, X3, X4 and X5 located on the die surface 116.

Still referring to FIG. 10, the motor 135 is used to adjust the position of the lens assembly 104 as described above. This motor is controlled by step controller 142, which receives control signals from CPU 156. The camera assembly will be exposed to a light source 154, specifically exposing the lens assembly 104 and camera die 116 on its surface 118, illustrated with the focal indicia X1, X2, X3, X4 and X5. In one embodiment, the motor control 142 and the light source 154 is controlled by the CPU 156, so that adjustments can be made to measure the focal points. The CPU may be connected to a storage device, such as memory 160, which may be a RAM, DRAM or other type of memory device. The memory may also exist on-chip with the CPU components. The memory 160 may include control system software 162 configured to store information related to CPU functions such as performing calculations, storing algorithms, or other software that, when executed by the CPU, causes the system to perform the novel method of testing and measuring as discussed above. The control system software may include adjustment control code in module 164 configured to enable the CPU to adjust the different components of the system, such as the motor 142 and other components. The software may further include a tilt computing module configured to enable the CPU to compute tilt data, such as focus data related to the focal points or areas X1, X2, X3, X4, and X5 located on the surface of the sensor chip to gather data for measuring tilt. The focus module may include algorithm software 168 to enable the CPU to perform the different tilt measurement algorithms of the system. The software may further include measuring module 170 having software that enables the CPU to perform measuring calculations, such as measuring the tilt of the sensor die using measured focus data. Lens sorting module 180 may also be included to enable the sorting of camera modules that do not pass a predetermined threshold for quality.

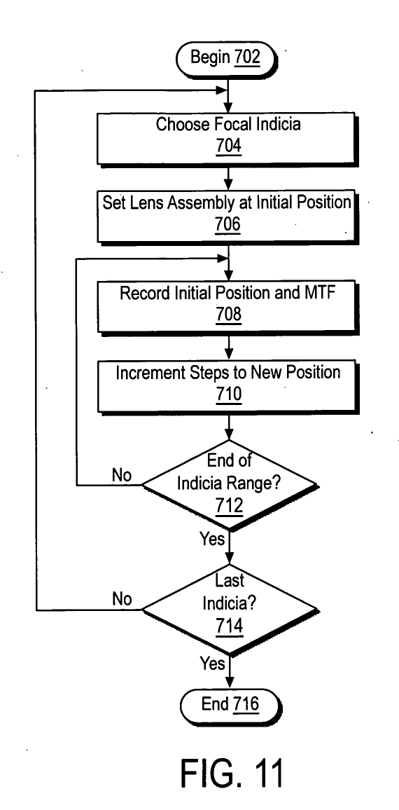

Referring to FIG. 11, one method of measuring the focal indicia is illustrated. This method illustrated perform the measurements separately for each indicia location. However, the process can also be performed simultaneously for all indicia locations. Those skilled in the art will understand that many possibilities will exist for performing such measurements without departing from the spirit and scope of the invention, which is defined by the appended claims and their equivalents. The process begins at step 702, and a focal indicia is chosen in step 704. The lens assembly is set at an initial position in step 706, and the position and MTF value at that position in step 708. The position is then changed at predetermined increments, or steps, in step 710. It is then determine if the range of measurement for that indicia has been covered in step 712. If it has not, then the process returns to Step 708, where the position and MTF is recorded, and the process proceeds again to step 710. If, again at step 712, the range has been covered, then the process goes to step 714 to determine if all indicia have been measured. If no, then another indicia is chosen at step 704, and the process proceeds again. If the last indicia has been measured, then the process ends at step 716.

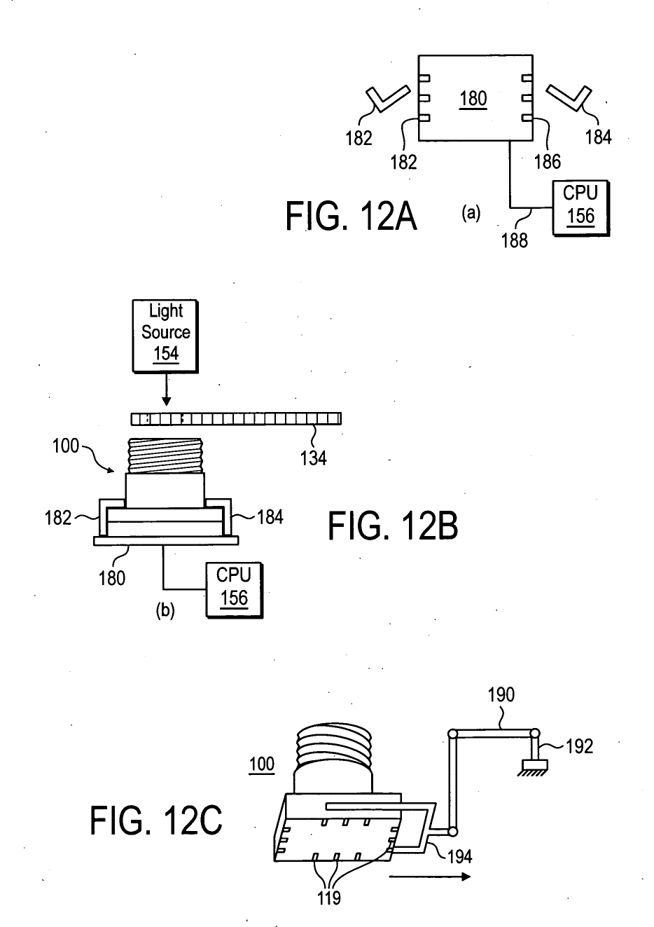

Those skilled in the art will understand the simple adaptability of this system to any automated production system. For example, referring to FIG. 12(a), the camera assembly 100 having electrical connections 119, such as a BGA or other type of contact, can be placed onto a testing mount 180 that has electrical contacts 186 corresponding to the camera assembly's electrical connections 119. The testing mount could also have clamps 182, 184, for example, to hold the camera assembly in place, and a connection 188 for communicating with CPU 156 and the rest of the system illustrated in FIG. 10. Once mounted in the assembly, referring to FIG. 12(b), the clamps 182, 184 can hold the camera assembly in place so that the light source 154 can transmit light through the lenses, as described above, so that the tilt of the sensor die can be tested and measured.

Given this system, the camera module can be fed into a testing mount of such a system by a robotic or other automation means, electronic contacts can be made to the camera module, and the system can test and measure a series of camera modules for camera tilt. For example, in FIG. 12c, a robotic arm 190 may be connected at one end to a robotic base 192 that controls the movements of the arm and to another end to a robotic clamp 194 that can grasp the camera assembly and place it in position for testing, such as on testing mount 180, and then clamped in with clamps 182, 184. Those skilled in the art will understand that there are many ways to adapt the novel testing and measurement system to automated processes. The invention, however, is not limited to any particular type of means of placing a camera assembly in a particular mount.

The invention has been described above as a system and method for testing and measuring a miniature camera assembly, including testing and measuring the tilt of a sensor die with respect to the optical axis of a camera lens. It will be apparent to those skilled in the art, however, that the spirit and scope of the invention extends to other areas where accurate testing and measurement of small devices are useful, and the scope of the invention is defined by the appended claims and their equivalents.

1. A method for measuring tilt of a sensor die with respect to the optical axis of the lens assembly in a camera module, comprising:
providing a camera module having a sensor die with a plurality of focal indicial located on a surface, and a lens or lens assembly adjustably held about the sensor die and having an optical axis;
exposing the lens to light; and
measuring the focus of each focal indicia with respect to the position of the lens; and
calculating the tilt of the sensor die with respect to the optical axis of the lens.

2. A method according to claim 1, further comprising changing the position of the lens when measuring each focal indicia.

3. A method according to claim 1, further comprising changing the position of the lens assembly when measuring each focal indicia across the surface of the sensor die and recording the measurements in a linear manner as measurements are taken across the sensor die.

4. A method according to claim 3, wherein the provided camera module has a lens assembly having at least one lens and is configured to adjust the distance between the lens and the sensor die by rotating the lens assembly, the method further comprising:
rotating the lens assembly to adjust the distance between the optical lens and the sensor die; and
measuring the MTF values of each focal indicia in a linear manner with respect to the position of the lens at different positions of the lens assembly with respect to the sensor die.

5. A method according to claim 2, further comprising
retrieving and recording focus measurement data; and
calculating the tilt of the sensor die with respect to the optical axis of the lens assembly using the focus measurement data.

6. A method according to claim 1, further comprising
changing the position of the at least one lens when measuring each focal indicia;
retrieving focus measurement data from measurements taken at a plurality of positions of the lens; and
calculating the tilt of the sensor die with respect to the optical axis using the focus measurement data.

7. A method according to claim 1, wherein the provided camera module includes a sensor die configured with a plurality of focal indicia located in predetermined locations on a die surface, and the lens is an adjustable lens assembly having a plurality of lenses having a common optical axis and that is configured to be adjusted in a manner to vary the focal distance between the at least one lens and the sensor die; the method further comprising:
changing the position of the lens assembly when measuring each focal indicia;
generating focus measurement data;
retrieving focus measurement data from measurements taken at a plurality of positions of the at least one lens; and
calculating the tilt of the sensor die with respect to the optical axis of the lens assembly using the focus measurement data.

8. A method according to claim 1, wherein the provided camera module includes a sensor die configured with a plurality of focal indicia located in at least three predetermined locations on a die surface facing the lens and an adjustable lens assembly that is configured to be adjusted in a manner to vary the focal distance between the at least one lens and the sensor die; the method further comprising:
changing the position of the at least one lens when measuring each focal indicia;
retrieving focus measurement data from measurements taken at a plurality of positions of the at least one lens; and
calculating the tilt of the sensor die using the focus measurement data.

9. A method according to claim 1, wherein one focal indicia is located in the center of the die, and four focal indicia are located at four equidistant locations on the surface of the sensor die, the method further comprising:
measuring each focal indicia in a plurality of locations;
recording a plurality of focus values for each focal indicia;
calculating the tilt of the sensor die with respect to the optical axis using selected focus values from the plurality of locations from each focal indicia.

10. A method according to claim 7, further comprising:
measuring each focal indicia in a plurality of locations;
changing the position of the lens while measuring the focal indicia;
recording a plurality of focus values for each focal indicia;
calculating the tilt of the sensor die with respect to the optical axis using selected focus values from the plurality of locations from each focal indicia.

11. A method according to claim 9, wherein the focus value of the focal indicia are measured according to a measurement transfer function (MTF).

12. A method according to claim 9, wherein the focal indicia are measured according to a MTF, wherein the focus of each point is measured when the lens is located in a plurality of positions with respect to the sensor die surface.

13. A method according to claim 9,
wherein the focal points are measured according to a MTF;
wherein the focus of each point is measured while the lens is moved within a range of positions with respect to the sensor die surface;
wherein focus measurements are recorded;
and wherein the tilt of the sensor die with respect to the optical axis is calculated using the MTF values recorded.

14. A method according to claim 9, wherein the lens assembly includes a plurality of lenses of substantially coincident focal range, wherein the focal indicia are measured according to a MTF, wherein the focus of each point is measured while the lens assembly is moved within a range of positions with respect to the sensor die surface, and wherein focus measurements and respective lens locations are recorded.

15. A method according to claim 13 or 14, further comprising
measuring an optimal focus value the corresponding location for each focal indicia; and
calculating the tilt using optimal focus value and the respective location for each indicia on the imager die.

16. A system for measuring tilt of a sensor die with respect to the optical axis of a lens assembly in a camera module having a sensor die with a plurality focal indicia located on a surface and a lens adjustably held about the sensor die and having a focal axis;
a light source configured to expose the lens to light; and
a measuring device configured to measure the focus of each focal indicia with respect to the position of the lens; and
an arithmetic device configured to calculate the tilt of the sensor die with respect to the optical axis of the lens.

17. A system according to claim 16, further comprising a holder for holding a camera module while being tested, wherein the lens of the provided camera module includes a lens assembly having a plurality of lenses with a common optical axis, the system further comprising an adjustment device configured to adjust the distance of lens assembly with respect to the sensor die while measuring the data used to calculate tilt.
